(19) United States
(12) Patent Application Publication
(10) Pub. No.: US 2025/0178466 A1
(43) Pub. Date: Jun. 5, 2025

(54) VEHICLE POWER SUPPLY SYSTEM

(71) Applicant: KABUSHIKI KAISHA TOYOTA JIDOSHOKKI, Aichi (JP)

(72) Inventor: Yusuke YAMAMOTO, Aichi (JP)

(73) Assignee: KABUSHIKI KAISHA TOYOTA JIDOSHOKKI, Aichi (JP)

(21) Appl. No.: 18/953,722

(22) Filed: Nov. 20, 2024

(30) Foreign Application Priority Data
Dec. 1, 2023 (JP) 2023-203846

(51) Int. Cl. B60L 53/20; B60L 1/00; H02M 7/797

(52) U.S. Cl. CPC B60L 53/20; B60L 1/006; H02M 7/797; B60L 2210/30; B60L 2210/42; B60L 2240/526

(57) ABSTRACT

A vehicle power supply system includes: a charging port; a bidirectional charger; an AC power port; a distribution board; and a controller for controlling an operation of the bidirectional charger. The bidirectional charger is configured to convert an AC power input from an external power source via the charging port and an external power supply line into a DC power to supply the DC power to a vehicle battery via a vehicle battery line, or convert the DC power input from the vehicle battery via the vehicle battery line into the AC power to supply the AC power to the external power supply line. The distribution board includes: a power distribution circuit configured to distribute the AC power input from the external power supply line to the AC power port; and a leakage current detector.

### CROSS-REFERENCE TO RELATED APPLICATION

This application claims priority to Japanese Patent Application No. 2023-203846 filed on Dec. 1, 2023, the entire disclosure of which is incorporated herein by reference.

The present disclosure relates to a vehicle power supply system.

### BACKGROUND ART

Some vehicle power supply systems may include a bidirectional charger. The bidirectional charger is configured to convert an alternating current (AC) power from an external power source into a direct current (DC) power to supply the DC power to a vehicle battery, and also convert the DC power from the vehicle battery into the AC power to supply the AC power to an AC power port (outlet) to which an electrical appliance is connected. The related technology is mentioned in Japanese Patent Application Publication No. 2023-074231 and Japanese Patent Application Publication No. 2023-115582.

If the number of AC power ports or the rated voltage needs to be changed according to the type or specifications of the vehicle, the configuration of the bidirectional charger may need to be changed. For example, if the number of AC power ports or the rated voltage is increased, components of a power distribution circuit or a leakage current detector in the bidirectional charger may need to be increased in the number or replaced with other components.

30 This may cause a change in the configuration of the bidirectional charger in the vehicle power supply system, thereby precluding standardization of the bidirectional charger across vehicles with different types and specifications.

The present disclosure, which has been made in light of the above-mentioned circumstance, is directed to providing a vehicle power supply system that allows standardization of a bidirectional charger across vehicles with different types and specifications even if the number of AC power ports or a rated voltage is changed according to the type and specifications of a vehicle in which the vehicle power supply system is mounted.

### SUMMARY

In accordance with an aspect of the present disclosure, there is provided a vehicle power supply system that includes: a charging port; a bidirectional charger; an AC power port; a distribution board; and a controller. The charging port is connected to an external power supply line. The bidirectional charger is connected to the external power supply line and a vehicle battery line. The bidirectional charger is configured to convert an AC power input from an external power source via the charging port and the external power supply line into a DC power to supply the DC power to a vehicle battery via the vehicle battery line, or convert the DC power input from the vehicle battery via the vehicle battery line into the AC power to supply the AC power to the external power supply line. The distribution board includes: a power distribution circuit configured to distribute the AC power input from the external power supply line to the AC power port; and a leakage current detector configured to detect leakage current. The controller is configured to control an operation of the bidirectional charger.

Other aspects and advantages of the disclosure will become apparent from the following description, taken in conjunction with the accompanying drawings, illustrating by way of example the principles of the disclosure.

### BRIEF DESCRIPTION OF THE DRAWINGS

The disclosure, together with objects and advantages thereof, may best be understood by reference to the following description of the embodiments together with the accompanying drawings in which:

FIG. 1 is a diagram of an example of a vehicle power supply system according to an embodiment;

FIG. 2 is a diagram of an example of a bidirectional charger;

FIG. 3 is a diagram of a vehicle power supply system according to a first modification;

FIG. 4 is a diagram of a vehicle power supply system according to a second modification; and

FIG. 5 is a diagram of a vehicle power supply system according to a third modification.

### DETAILED DESCRIPTION OF THE EMBODIMENTS

The following will describe an embodiment and modifications of the present disclosure in detail with reference to the accompanying drawings.

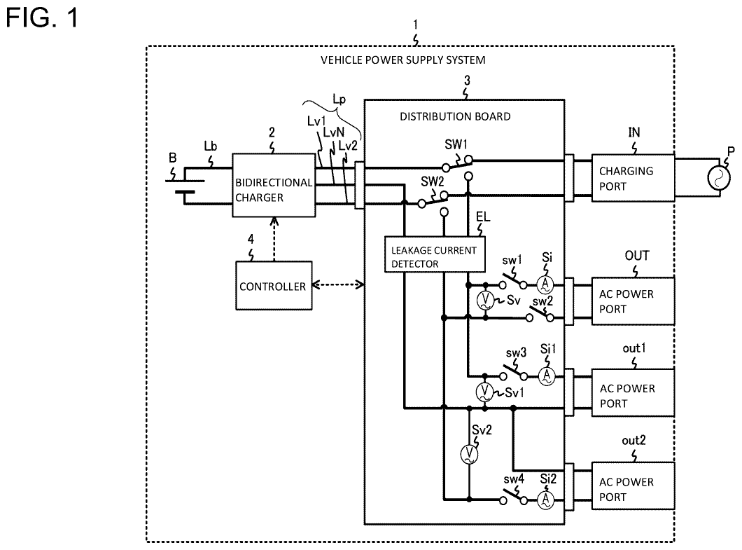

FIG. 1 is a diagram of an example of a vehicle power supply system according to the embodiment.

FIG. 1 is a diagram of a vehicle power supply system 1 that includes a vehicle battery B, a charging port IN, a bidirectional charger 2, an alternating current (AC) power port OUT (first AC power port), a plurality of AC power ports out1 and out2 (second AC power ports), a distribution board 3, and a controller 4. For example, the vehicle power supply system 1 is mounted in a vehicle, such as an electric vehicle or a plug-in hybrid vehicle. The vehicle power supply system 1 is configured to convert an AC power output from an external power source P, such as a commercial power source, into a DC power to supply the DC power to the vehicle battery B. The vehicle power supply system 1 is also configured to convert the DC power output from the vehicle battery B into the AC power to supply the AC power to the AC power ports OUT, out1, and out2. The rated voltage of the AC power port OUT is greater than the rated voltage of the AC power ports out1 and out2. For example, the rated voltage of the AC power port OUT is 200 V AC and the rated voltage of the AC power ports out1 and out2 is 100 V AC.

The vehicle battery B is, for example, a rechargeable battery, such as a lithium ion secondary battery, and supplies power to a drive device, such as a traveling motor.

The charging port IN is, for example, an inlet that is connected to a connector of a charging cable (not illustrated), and is disposed on the side surface of a body of the vehicle, for example. The AC power is supplied from the external power source P to an external charger (not illustrated), and the external charger is connected to the vehicle power supply system 1 via the charging cable that is connected to the charging port IN.

The bidirectional charger 2 is connected to an external power supply line Lp, which is connected to the charging port IN, and to a vehicle battery line Lb, which is connected to the vehicle battery B. The bidirectional charger 2 converts the AC power input from the external power source P via the charging port IN and the external power supply line Lp into the DC power to supply the DC power to the vehicle battery B via the vehicle battery line Lb. Alternatively, the bidirectional charger 2 converts the DC power input from the vehicle battery B via the vehicle battery line Lb into the AC power to supply the AC power to the external power supply line Lp. The external power supply line Lp has a voltage line Lv1, a voltage line Lv2, and a neutral line LvN.

The AC power port OUT is an outlet to which a plug of an electrical appliance (e.g., an induction cooker) powered by 200 V AC is connected, and is disposed in a console box of the vehicle, for example. Each of the AC power ports out1 and out2 is an outlet to which a plug of an electrical appliance (e.g., a personal computer or a television) powered by 100 V AC is connected. For example, one of the AC power ports out1 and out2 is disposed in the console box of the vehicle, and the other is disposed in a rear area in the vehicle. The vehicle power supply system 1 may include two or more AC power ports OUT. The vehicle power supply system 1 may include one AC power port out, or the vehicle power supply system 1 may include three or more AC power ports out. The vehicle power supply system 1 may include an AC power port OUT only without including an AC power port out, or the vehicle power supply system 1 may include an AC power port out only without including an AC power port OUT.

The distribution board 3 includes a power distribution circuit, a plurality of current detectors Si, Si1, and Si2, a plurality of voltage detectors Sv, Sv1, and Sv2, and a leakage current detector EL, which will be described later.

The power distribution circuit includes a plurality of changeover switches SW1 and SW2, and a plurality of disconnect switches sw1 to sw4, and distributes the AC power input from the external power supply line Lp to the AC power ports OUT, out1, and out2. For example, when the bidirectional charger 2 supplies the AC power of 6 KW to the external power supply line Lp, the power distribution circuit supplies the AC power of 3 KW to the AC power port OUT, and supplies the AC power of 1.5 KW to each of the AC power ports out1 and out2.

The changeover switches SW1 and SW2 are electromagnetic relays with changeover contact, for example. The changeover switch SW1 is connected between the voltage line Lv1 of the external power supply line Lp and one of the terminals of the charging port IN and between the voltage line Lv1 of the external power supply line Lp and one of the terminals of each of the AC power ports OUT, out1, and out2. The changeover switch SW2 is connected between the voltage line Lv2 of the external power supply line Lp and the other of the terminals of the charging port IN and between the voltage line Lv2 of the external power supply line Lp and the other of the terminals of each of the AC power ports OUT, out1, and out2. The controller 4 controls the operations of the changeover switches SW1 and SW2 so that the external power supply line Lp (voltage lines Lv1 and Lv2) is connected to the charging port IN, or connected to the AC power ports OUT, out1, and out2 via the disconnect switches sw1 to sw4. That is, the changeover switches SW1 and SW2 are configured to switch the port to which the external power supply line Lp is connected between the charging port IN and the AC power ports OUT, out1, and out2.

The disconnect switches sw1 and sw2 are electromagnetic relays with normally open contact or normally closed contact, for example. The disconnect switch sw1 is connected between the voltage line Lv1 of the external power supply line Lp and one of the terminals of the AC power port OUT via the changeover switch SW1. The disconnect switch sw2 is connected between the voltage line Lv2 of the external power supply line Lp and the other of the terminals of the AC power port OUT via the changeover switch SW2. When the controller 4 controls the disconnect switches sw1 and sw2 so that the disconnect switches sw1 and sw2 are in a conducting state, the external power supply line Lp (voltage lines Lv1 and Lv2) is electrically connected to the AC power port OUT via the changeover switches SW1 and SW2. When the controller 4 controls the disconnect switches sw1 and sw2 so that the disconnect switches sw1 and sw2 are in a disconnecting state, the external power supply line Lp (voltage lines Lv1 and Lv2) is electrically disconnected from the AC power port OUT. Either one of the disconnect switches sw1 and sw2 may be omitted.

The disconnect switch sw3 is an electromagnetic relay with normally open contact or normally closed contact, for example, and is connected between the voltage line Lv1 of the external power supply line Lp and one of the terminals of the AC power port out1 via the changeover switch SW1. The other of the terminals of the AC power port out1 is connected to the neutral line LvN of the external power supply line Lp. When the controller 4 controls the disconnect switch sw3 so that the disconnect switch sw3 is in a conducting state, the external power supply line Lp (voltage line Lv1 and neutral line LvN) is electrically connected to the AC power port out1 via the changeover switch SW1. When the controller 4 controls the disconnect switch sw3 so that the disconnect switch sw3 is in a disconnecting state, the external power supply line Lp (voltage line Lv1 and neutral line LvN) is electrically disconnected from the AC power port out1.

The disconnect switch sw4 is an electromagnetic relay with normally open contact or normally closed contact, for example, and is connected between the voltage line Lv2 of the external power supply line Lp and one of the terminals of the AC power port out2 via the changeover switch SW2. The other of the terminals of the AC power port out2 is connected to the neutral line LvN of the external power supply line Lp. When the controller 4 controls the disconnect switch sw4 so that the disconnect switch sw4 is in a conducting state, the external power supply line Lp (voltage line Lv2 and neutral line LvN) is electrically connected to the AC power port out2 via the changeover switch SW2. When the controller 4 controls the disconnect switch sw4 so that the disconnect switch sw4 is in a disconnecting state, the external power supply line Lp (voltage line Lv2 and neutral line LvN) is electrically disconnected from the AC power port out2.

Each of the current detectors Si, Si1, and Si2 includes a Hall element or a shunt resistor, for example. When the disconnect switches sw1 and sw2 are in a conducting state and the external power supply line Lp is connected to the AC power port OUT by the changeover switches SW1 and SW2, the current detector Si detects the current flowing through the external power supply line Lp to the AC power port OUT and sends information on the detected current to the controller 4. When the disconnect switch sw3 is in a conducting state and the external power supply line Lp is connected to the AC power port out1 by the changeover switches SW1 and SW2, the current detector Si1 detects the current flowing through the external power supply line Lp to the AC power port out1 and sends information on the detected current to the controller 4. When the disconnect switch sw4 is in a conducting state and the external power supply line Lp is connected to the AC power port out2 by the changeover switches SW1 and SW2, the current detector Si2 detects the current flowing through the external power supply line Lp to the AC power port out2 and sends information on the detected current the controller 4.

Each of the voltage detectors Sv, Sv1, and Sv2 includes a voltage dividing resistor, for example. When the disconnect switches sw1 and sw2 are in a conducting state and the external power supply line Lp is connected to the AC power port OUT by the changeover switches SW1 and SW2, the voltage detector Sv detects the voltage input to the AC power port OUT and sends information on the detected voltage to the controller 4. When the disconnect switch sw3 is in a conducting state and the external power supply line Lp is connected to the AC power port out1 by the changeover switches SW1 and SW2, the voltage detector Sv1 detects the voltage input to the AC power port out1 and sends information on the detected voltage to the controller 4. When the disconnect switch sw4 is in a conducting state and the external power supply line Lp is connected to the AC power port out2 by the changeover switches SW1 and SW2, the voltage detector Sv2 detects the voltage input to the AC power port out2 and sends information on the detected voltage to the controller 4.

The leakage current detector EL is, for example, a ground fault circuit interrupter (GFCI) and detects leakage current in paths between the external power supply line Lp (voltage line Lv1, voltage line Lv2, and neutral line LvN) and the AC power ports OUT, out1, and out2. For example, the leakage current detector EL includes a current sensor (e.g., a current transformer) for detecting the current flowing in each of the paths between the external power supply line Lp (voltage line Lv1, voltage line Lv2, and neutral line LvN) and the AC power ports OUT, out1, and out2, and a leakage current determination unit (e.g., an integrated circuit). When the external power supply line Lp is connected to some of the AC power ports OUT, out1, and out2, the leakage current determination unit determines whether or not there is a leakage current in the corresponding line or lines based on the current detected by the current sensor in the leakage current detector EL. The leakage current determination unit determines that there is a leakage current in the path when the balance of current flowing through the conductive line (the difference between the current flowing from the bidirectional charger 2 to each of the conductive AC power ports OUT, out1, and out2 and the current flowing from each of the conductive AC power ports OUT, out1, and out2 to the bidirectional charger 2) is equal to or greater than a predetermined current threshold value. Whether the line is electrically connected to or disconnected from the AC power ports OUT, out1, and out2 depends on the status of the changeover switches SW1 and SW2 and the disconnect switches sw1 to sw4.

The controller 4 includes a processor or a programmable device, such as a field programmable gate array (FPGA) or a programmable logic device (PLD), and is configured to control the operations of the bidirectional charger 2 and the distribution board 3. The controller 4 may be provided in the bidirectional charger 2 or the distribution board 3. Alternatively, each of the bidirectional charger 2 and the distribution board 3 may include a controller. The controller of the bidirectional charger 2 and the controller of the distribution board 3 may control the operation of the bidirectional charger 2 and the operation of the distribution board 3, respectively, and exchange data to cooperate to perform the operations of the controller 4, which will be described later.

For example, in order to charge the vehicle battery B, the controller 4 controls the changeover switches SW1 and SW2 so that the external power supply line Lp is connected to the charging port IN and controls the disconnect switches sw1 to sw4 so that the disconnect switches sw1 to sw4 enter a disconnecting state. The controller 4 controls the operation of the bidirectional charger 2 so that the bidirectional charger 2 converts the AC power output from the external power source P into the DC power to supply the DC power to the vehicle battery B.

Further, in order to supply the power to the AC power ports OUT, out1, and out2, the controller 4 controls the disconnect switches sw1 to sw4 so that the disconnect switches sw1 to sw4 enter a conducting state, and controls the changeover switches SW1 and SW2 so that the external power supply line Lp is connected to the AC power ports OUT, out1, and out2. The controller 4 controls the operation of the bidirectional charger 2 so that the bidirectional charger 2 converts the DC power output from the vehicle battery B into the AC power to supply the AC power to the AC power ports OUT, out1, and out2. For example, when the controller 4 controls the operation of the bidirectional charger 2 so that the bidirectional charger 2 outputs single-phase three-wire AC power, specifically, when the bidirectional charger 2 supplies a first AC power (e.g., 200 V AC) between the voltage line Lv1 and the voltage line Lv2, a second AC power (e.g., 100 V AC) between the voltage line Lv1 and the neutral line LvN, and the second AC power (e.g., 100 V AC) between the voltage line Lv2 and the neutral line LvN, an AC voltage of 200 V AC is supplied to the AC power port OUT, and an AC voltage of 100 V AC is supplied to each of the AC power ports out1 and out2. This allows the AC power port OUT and the AC power ports out1 and out2 to output different AC voltages simultaneously, thereby allowing multiple electrical appliances with different driving voltages to be used simultaneously in a vehicle equipped with the vehicle power supply system 1.

If the user requests power supply only to the AC power port OUT, the controller 4 controls the disconnect switches sw1 to sw4 so that the disconnect switches sw1 and sw2 enter a conducting state and the disconnect switches sw3 and sw4 enter a disconnecting state, and controls the changeover switches SW1 and SW2 so that the external power supply line Lp is connected to the AC power port OUT. The controller 4 controls the operation of the bidirectional charger 2 so that the bidirectional charger 2 converts the DC power output from the vehicle battery B into the single-phase three-wire AC power to supply the single-phase three-wire AC power to the external power supply line Lp. This allows the AC power to be output only from the AC power port OUT. The bidirectional charger 2 may supply a single-phase AC power between the voltage line Lv1 and the voltage line Lv2.

If the user requests power supply only to the AC power port out1, the controller 4 controls the disconnect switches sw1 to sw4 so that the disconnect switch sw3 enters a conducting state and the disconnect switches sw1, sw2, and sw4 enter a disconnecting state, and controls the changeover switches SW1 and SW2 so that the external power supply line Lp is connected to the AC power port out1. The controller 4 controls the operation of the bidirectional charger 2 so that the bidirectional charger 2 converts the DC power output from the vehicle battery B into the single-phase three-wire AC power to supply the single-phase three-wire AC power to the external power supply line Lp. This allows the AC power to be output only from the AC power port out1. The bidirectional charger 2 may supply a single-phase AC power between the voltage line Lv1 and the neutral line LvN.

If the user requests power supply only to the AC power port out2, the controller 4 controls the disconnect switches sw1 to sw4 so that the disconnect switch sw4 enters a conducting state and the disconnect switches sw1 to sw3 enter a disconnecting state, and controls the changeover switches SW1 and SW2 so that the external power supply line Lp is connected to the AC power port out2. The controller 4 controls the operation of the bidirectional charger 2 so that the bidirectional charger 2 converts the DC power output from the vehicle battery B into the single-phase three-wire AC power to supply the single-phase three-wire AC power to the external power supply line Lp. This allows the AC power to be output only from the AC power port out2. The bidirectional charger 2 may supply a single-phase AC power between the voltage line Lv2 and the neutral line LvN.

If the leakage current detector EL detects a leakage current during the power supply to the AC power ports OUT, out1, and out2, the controller 4 stops the bidirectional charger 2 and controls the disconnect switches sw1 to sw4 so that the disconnect switches sw1 to sw4 are switched from a conducting state to a disconnecting state. Alternatively, if the leakage current detector EL detects a leakage current during the power supply to the AC power ports OUT, out1, and out2, the controller 4 does not stop the bidirectional charger 2 and controls the disconnect switches sw1 to sw4 so that the disconnect switches sw1 to sw4 are switched from a conducting state to a disconnecting state. This prevents unintended leakage current at the AC power ports OUT, out1, and out2.

If the current detector Si detects the current equal to or greater than a current threshold value Ith during the power supply to the AC power port OUT, the controller 4 determines that an overcurrent abnormality has occurred in which a relatively large current flows to the AC power port OUT, and controls the disconnect switches sw1 to sw4 so that the disconnect switches sw1 and sw2 are switched from a conducting state to a disconnecting state and the state of the disconnect switches sw3 and sw4 is maintained. If the power is being supplied to the AC power ports out1 and out2, the disconnect switches sw3 and sw4 are maintained in a conducting state. The current threshold value Ith is a value based on the rated current of the AC power port OUT. This allows the power supply to the AC power port OUT to be immediately stopped and the power supply to the AC power ports out1 and out2 to continue if a relatively large current flows to the AC power port OUT due to a short circuit anomaly or the like.

If the current detector Si1 detects the current equal to or greater than a current threshold value Ith1 during the power supply to the AC power port out1, the 20) controller 4 determines that an overcurrent abnormality has occurred in which a relatively large current flows to the AC power port out1, and controls the disconnect switches sw1 to sw4 so that the disconnect switch sw3 is switched from a conducting state to a disconnecting state and the state of the disconnect switches sw1, sw2, and sw4 is maintained. If the power is being supplied to the AC power ports OUT and out2, the disconnect switches sw1, sw2, and sw4 are maintained in a conducting state. The current threshold value Ith1 is a value based on the rated current of the AC power port out1. This allows the power supply to the AC power port out1 to be immediately stopped and the power supply to the AC power ports OUT and out2 to continue if a relatively large current flows to the AC power port out1 due to a short circuit anomaly or the like.

If the current detector Si2 detects the current equal to or greater than a current threshold value Ith2 during the power supply to the AC power port out2, the controller 4 determines that an overcurrent abnormality has occurred in which a relatively large current flows to the AC power port out2, and controls the disconnect switches sw1 to sw4 so that the disconnect switch sw4 is switched from a conducting state to a disconnecting state and the state of the disconnect switches sw1 to sw3 is maintained. If the power is being supplied to the AC power ports OUT and out1, the disconnect switches sw1 to sw3 are maintained in a conducting state. The current threshold value Ith2 is a value based on the rated current of the AC power port out2. This allows the power supply to the AC power port out2 to be immediately stopped and the power supply to the AC power ports OUT and out1 to continue if a relatively large current flows to the AC power port out2 due to a short circuit anomaly or the like.

If the voltage detector Sv detects the voltage equal to or greater than a voltage threshold value Vth during the power supply to the AC power port OUT, the controller 4 determines that an overvoltage abnormality has occurred in which a relatively high voltage is applied to the AC power port OUT, and controls the disconnect switches sw1 to sw4 so that the disconnect switches sw1 and sw2 are switched from a conducting state to a disconnecting state and the state of the disconnect switches sw3 and sw4 is maintained. If the power is being supplied to the AC power ports out1 and out2, the disconnect switches sw3 and sw4 are maintained in a conducting state. The voltage threshold value Vth is a value based on the rated voltage of the AC power port OUT. This allows the power supply to the AC power port OUT to be immediately stopped and the power supply to the AC power ports out1 and out2 to continue if a relatively high voltage is applied to the AC power port OUT due to a short circuit anomaly or the like.

If the voltage detector Sv1 detects the voltage equal to or greater than a voltage threshold value Vth1 during the power supply to the AC power port out1, the controller 4 determines that an overvoltage abnormality has occurred in which a relatively high voltage is applied to the AC power port out1, and controls the disconnect switches sw1 to sw4 so that the disconnect switch sw3 is switched from a conducting state to a disconnecting state and the state of the disconnect switches sw1, sw2, and sw4 is maintained. If the power is being supplied to the AC power ports OUT and out2, the disconnect switches sw1, sw2, and sw4 are maintained in a conducting state. The voltage threshold value Vth1 is a value based on the rated voltage of the AC power port out1. This allows the power supply to the AC power port out1 to be immediately stopped and the power supply to the AC power ports OUT and out2 to continue if a relatively high voltage is applied to the AC power port out1 due to a short circuit anomaly or the like.

If the voltage detector Sv2 detects the voltage equal to or greater than a voltage threshold value Vth2 during the power supply to the AC power port out2, the controller 4 determines that an overvoltage abnormality has occurred in which a relatively high voltage is applied to the AC power port out2, and controls the disconnect switches sw1 to sw4 so that the disconnect switch sw4 is switched from a conducting state to a disconnecting state and the state of the disconnect switches sw1 to sw3 is maintained. If the power is being supplied to the AC power ports OUT and out1, the disconnect switches sw1 to sw3 are maintained in a conducting state. The voltage threshold value Vth2 is a value based on the rated voltage of the AC power port out2. This allows the power supply to the AC power port out2 to be immediately stopped and the power supply to the AC power ports OUT and out1 to continue if a relatively high voltage is applied to the AC power port out2 due to a short circuit anomaly or the like.

In such a manner, in the vehicle power supply system 1 according to the present embodiment, the power distribution circuit and leakage current detector EL are not provided in the bidirectional charger 2 but in the distribution board 3, and the bidirectional charger 2 has only a power conversion function.

This configuration eliminates the need to change the configuration of the bidirectional charger 2 even if the configuration of the power distribution circuit or the leakage current detector EL is changed due to a change in the number of AC power ports or the rated voltage, thereby allowing standardization of the bidirectional charger 2 across vehicles with different types and specifications. In addition, this configuration allows the rated power of a component (e.g., a current transformer) used in the leakage current detector EL to be adjusted to the rated power of the AC power ports OUT, out1, and out2, which is lower than the DC power supplied to the vehicle battery B. This configuration therefore allows for avoiding the need to increase the size of the component used in the leakage current detector EL compared to a configuration in which the leakage current detector EL is provided in the bidirectional charger 2, thereby avoiding the need to increase the size of the vehicle power supply system 1.

Furthermore, the vehicle power supply system 1 according to the present embodiment includes the voltage detector Sv and the current detector Si for the AC power port OUT, the voltage detector Sv1 and the current detector Si1 for the AC power port out1, and the voltage detector Sv2 and the current detector Si2 for the AC power port out2.

This configuration allows determination of the occurrence of overvoltage abnormalities or overcurrent abnormalities at each of the AC power ports OUT, out1, and out2 based on the voltage detected by the voltage detectors Sv, Sv1, and Sv2 or the current detected by the current detectors Si, Si1, and Si2.

Furthermore, the vehicle power supply system 1 according to the present embodiment includes the disconnect switches sw1 and sw2 between the external power supply line Lp and the AC power port OUT, the disconnect switch sw3 between the external power supply line Lp and the AC power port out1, and the disconnect switch sw4 between the external power supply line Lp and the AC power port out2.

This configuration allows the external power supply line Lp to be connected to or disconnected from the AC power ports OUT, out1, and out2 selectively according to the occurrence of abnormalities or the user's request, thereby increasing the flexibility of the power distribution function of the distribution board 3 compared to a configuration in which current limitation is performed collectively upstream of the AC power ports OUT, out1, and out2.

Furthermore, the vehicle power supply system 1 according to the present embodiment has the charging port IN that is connected to the external power supply line Lp via the distribution board 3.

This configuration eliminates the need for a connection terminal or the like for connecting the charging port IN to the external power supply line Lp, thereby allowing standardization of the external power supply line Lp.

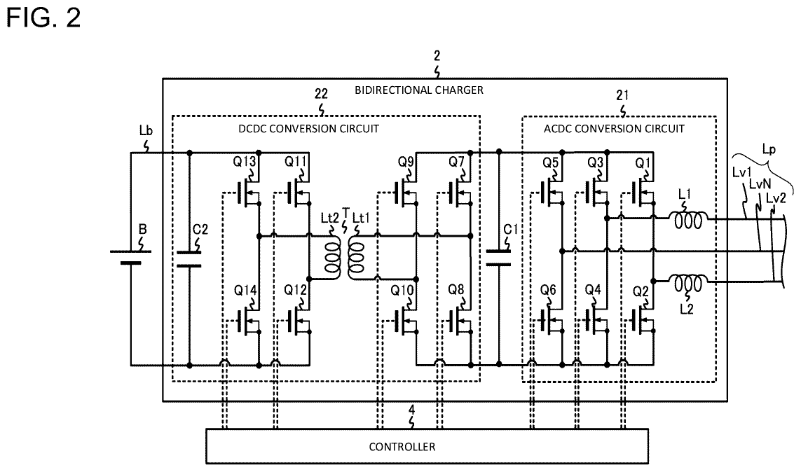

FIG. 2 is a diagram of an example of the bidirectional charger 2.

The bidirectional charger 2 illustrated in FIG. 2 includes an ACDC conversion circuit 21, a capacitor C1, and a DCDC conversion circuit 22.

The ACDC conversion circuit 21 includes inductors L1 and L2 and switching elements Q1 to Q6. Each of the switching elements Q1 to Q6 is, for example, a metal oxide semiconductor field-effect transistor (MOSFET). The switching elements Q5 and Q6 may be replaced with capacitors.

One of the terminals of the inductor L1 is connected to the voltage line Lv1 of the external power supply line Lp, and the other of the terminals of the inductor L1 is connected to the connection point between the source terminal of the switching element Q3 and the drain terminal of the switching element Q4. One of the terminals of the inductor L2 is connected to the voltage line Lv2 of the external power supply line Lp, and the other of the terminals of the inductor L2 is connected to the connection point between the source terminal of the switching element Q1 and the drain terminal of the switching element Q2. The connection point between the source terminal of the switching element Q5 and the drain terminal of the switching element Q6 is connected to the neutral line LvN of the external power supply line Lp. The drain terminals of the switching elements Q1, Q3, and Q5 are connected to one of the terminals of the capacitor C1, and the source terminals of the switching elements Q2, Q4, and Q6 are connected to the other of the terminals of the capacitor C1.

The capacitor C1 is connected between the ACDC conversion circuit 21 and the DCDC conversion circuit 22.

The DCDC conversion circuit 22 is a so-called dual active bridge (DAB) circuit, and includes a transformer T, switching elements Q7 to Q10 that form a bridge circuit on the primary side of the transformer T, switching elements Q11 to Q14 that form a bridge circuit on the secondary side of the transformer T, and a capacitor C2. Each of the switching elements Q7 to Q14 is, for example, a MOSFET.

The drain terminals of the switching elements Q7 and Q9 are connected to the one of the terminals of the capacitor C1, and the source terminals of the switching elements Q8 and Q10 are connected to the other of the terminals of the capacitor C1. The connection point between the source terminal of the switching element Q7 and the drain terminal of the switching element Q8 is connected to one 20 of the terminals of a primary coil Lt1 of the transformer T, and the connection point between the source terminal of the switching element Q9 and the drain terminal of the switching element Q10 is connected to the other of the terminals of the primary coil Lt1. The drain terminals of the switching elements Q11 and Q13 are connected to the one of the terminals of the capacitor C2, and the source terminals of the switching elements Q12 and Q14 are connected to the other of the terminals of the capacitor C2. The connection point between the source terminal of the switching element Q11 and the drain terminal of the switching element Q12 is connected to one of the terminals of a secondary coil Lt2 of the transformer T, and the connection point between the source terminal of the switching element Q13 and the drain terminal of the switching element Q14 is connected to the other of the terminals of the secondary coil Lt2. The one of the terminals of the capacitor C2 is connected to the positive terminal of the vehicle battery B, and the other of the terminals of the capacitor C2 is connected to the negative terminal of the vehicle battery B.

The bidirectional charger 2 includes a desired current sensor and a voltage sensor (not illustrated), and the controller 4 controls the operations of the ACDC conversion circuit 21 and the DCDC conversion circuit 22 according to values detected by the current sensor and the voltage sensor.

While the vehicle battery B is charged, the controller 4 controls the operations of the ACDC conversion circuit 21 and the DCDC conversion circuit 22 so that the ACDC conversion circuit 21 and the DCDC conversion circuit 22 convert the AC power input from the external power supply line Lp into the DC power to supply the DC power to the vehicle battery B. While the power is supplied to the AC power ports OUT, out1, and out2, the controller 4 controls the operations of the ACDC conversion circuit 21 and the DCDC conversion circuit 22 so that the ACDC conversion circuit 21 and the DCDC conversion circuit 22 convert the DC power output from the vehicle battery B into the AC power to supply the AC power to the external power supply line Lp.

For example, while the vehicle battery B is charged, the controller 4 controls the switching elements Q1 to Q4 in order to maintain a power factor close to 1. Accordingly, the rectified power with the power factor improved by the ACDC conversion circuit 21 is supplied to the capacitor C1. The capacitor C1 smooths the power rectified by the ACDC conversion circuit 21. That is, while the vehicle battery B is charged, the AC power input from the external power supply line Lp is 25 converted into the DC power by the ACDC conversion circuit 21 and the capacitor C1, and output to the DCDC conversion circuit 22.

While the vehicle battery B is charged, the controller 4 controls the switching elements Q7 to Q14 so that the switching elements Q7 to Q14 convert the DC power converted by the ACDC conversion circuit 21 and the capacitor C1 into a target DC power.

While the power is supplied to the AC power ports OUT, out1, and out2, the controller 4 controls the switching elements Q7 to Q14 so that the switching elements Q7 to Q14 convert the DC power output from the vehicle battery B into a predetermined DC power to input the predetermined DC power to the ACDC conversion circuit 21 via the capacitor C1.

While the power is supplied to the AC power ports OUT, out1, and out2, the controller 4 controls the switching elements Q1 to Q6 so that the switching elements Q1 to Q6 convert the predetermined DC power output from the DCDC conversion circuit 22 into the first AC power and the second AC power to output the first AC power to the voltage line Lv1 and the neutral line LvN and to output the second AC power to the voltage line Lv2 and the neutral line LvN.

The bidirectional charger 2 is not limited to the configuration illustrated in FIG. 2. A charging circuit and a DCAC conversion circuit connected in parallel may cooperate to serve as the bidirectional charger 2. In this configuration, the charging circuit is configured to only convert the AC power input to the external power supply line Lp into the DC power to charge the vehicle battery B, and the DCAC conversion circuit is configured to only convert the DC power of the vehicle battery B into the AC power to output the AC power to the external power supply line Lp.

The present disclosure is not limited to the above-described embodiment, and various improvements and modifications are allowed without departing from the gist of the present disclosure.

### First Modification

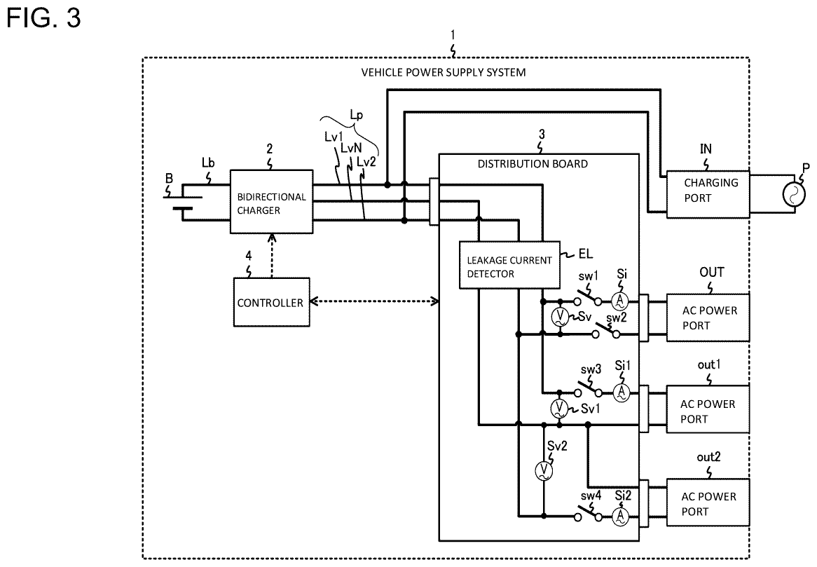

FIG. 3 is a diagram of the vehicle power supply system 1 according to a first modification. In FIG. 3, the same components as those illustrated in FIG. 1 are denoted by the same reference numerals, and the description thereof will be omitted.

The vehicle power supply system 1 illustrated in FIG. 3 differs from the vehicle power supply system 1 illustrated in FIG. 1 in that the charging port IN is directly connected to the external power supply line Lp without passing through the distribution board 3.

This configuration eliminates the need for the changeover switches SW1 and SW2 illustrated in FIG. 1.

Similarly to the configuration of the vehicle power supply system 1 illustrated in FIG. 1, the configuration of the vehicle power supply system 1 illustrated in FIG. 3 according to the first modification does not need to change the configuration of the bidirectional charger 2, thereby allowing standardization of the bidirectional charger 2 across vehicles with different types and specifications.

### Second Modification

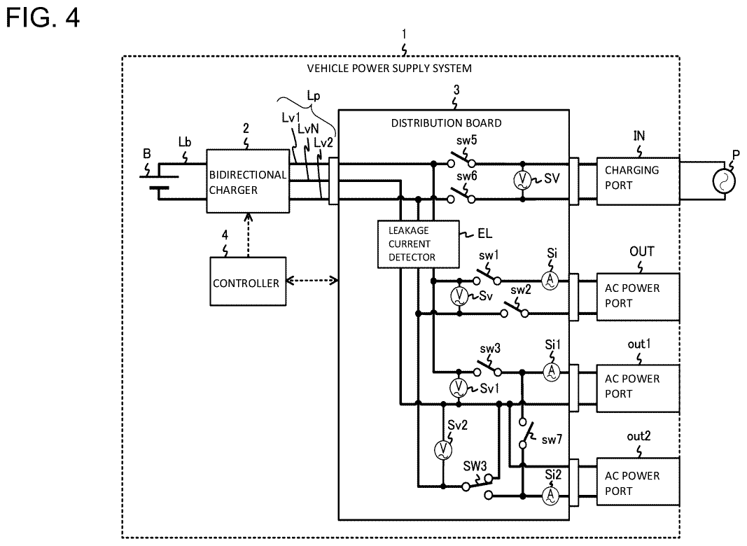

FIG. 4 is a diagram of the vehicle power supply system 1 according to a second modification. In FIG. 4, the same components as those illustrated in FIG. 1 are denoted by the same reference numerals, and the description thereof will be omitted.

The vehicle power supply system 1 illustrated in FIG. 4 differs from the vehicle power supply system 1 illustrated in FIG. 1 in that the configuration of the power distribution circuit (disconnect switch and changeover switch) of the distribution board 3 is changed so that power is supplied to the AC power port OUT or the AC power ports out1 and out2 while the vehicle battery B is charged. That is, the vehicle power supply system 1 illustrated in FIG. 4 is capable of supplying power to the AC power port OUT or the AC power ports out1 and out2 while charging the vehicle battery B using the AC power output from the external power source P. The power distribution circuit of the distribution board 3 illustrated in FIG. 4 includes: disconnect switches sw5 and sw6 instead of the changeover switches SW1 and SW2; and a changeover switch SW3 instead of the disconnect switch sw4, and further includes a disconnect switch sw7 and a charging voltage detector SV. Similarly to the vehicle power supply system 1 illustrated in FIG. 1, the disconnect switches sw1, sw2, sw3, sw5, sw6, and sw7 of the vehicle power supply system 1 illustrated in FIG. 4 according to the second modification may be controlled so that the charging port IN is connected to or disconnected from the AC power ports OUT, out1, and out2 selectively according to the occurrence of abnormalities or the user's request.

The disconnect switches sw5 and sw6 are electromagnetic relays with normally open contact or normally closed contact, for example. The disconnect switch sw5 is connected between the voltage line Lv1 of the external power supply line Lp and the one of the terminals of the charging port IN, and the disconnect switch sw6 is connected between the voltage line Lv2 of the external power supply line Lp and the other of the terminals of the charging port IN. When the controller 4 controls the disconnect switches sw5 and sw6 so that the disconnect switches sw5 and sw6 are in a conducting state, the external power supply line Lp (voltage lines Lv1 and Lv2) is electrically connected to the charging port IN. When the controller 4 controls the disconnect switches sw5 and sw6 so that the disconnect switches sw5 and sw6 are in a disconnecting state, the external power supply line Lp (voltage lines Lv1 and Lv2) is electrically disconnected from the charging port IN. The voltage lines Lv1 and Lv2 are connected to the AC power ports without passing through the disconnect switches sw5 and sw6. This configuration allows the AC power ports to be connected to the bidirectional charger 2 and the charging port IN simultaneously. Either one of the disconnect switches sw5 and sw6 may be omitted.

The changeover switch SW3 is an electromagnetic relay with changeover contact, for example, and is connected between the other of the terminals of the charging port IN, the other of the terminals of the AC power port out1, and the one of the terminals of the AC power port out2 via the disconnect switch sw6. The controller 4 controls the changeover switch SW3 so that the other of the terminals of the charging port IN is connected to the other terminals of the AC power ports out1 and out2 via the disconnect switch sw6, or connected to the one of the terminals of the AC power port out2. That is, the changeover switch SW3 is configured to switch the terminal to which the other of the terminals of the charging port IN is connected via the disconnect switch sw6 between the external power supply line Lp between the other terminals of the AC power ports out1 and out2 and the one of the terminals of the AC power port out2.

The disconnect switch sw7 is an electromagnetic relay with normally open contact or normally closed contact, for example, and is connected between the one of the terminals of the AC power port out1 and the one of the terminals of the AC power port out2. When the controller 4 controls the disconnect switch sw7 so that the disconnect switch sw7 is in a conducting state, the one of the terminals of the AC power port out1 is electrically connected to the one of the terminals of the AC power port out2. When the controller 4 controls the disconnect switch sw7 so that the disconnect switch sw7 is in a disconnecting state, the one of the terminals of the AC power port out1 is electrically disconnected from the one of the terminals of the AC power port out2.

The charging voltage detector SV includes a voltage dividing resistor, for example. When the disconnect switches sw5 and sw6 are in a conducting state and the AC power is supplied from the external power source P to the charging port IN, the charging voltage detector SV detects the voltage input from the charging port IN and sends information on the detected voltage to the controller 4. The charging voltage detector SV may be provided in the bidirectional charger 2.

### First Example of Operation of Controller 4

The following will describe a first example of operation of the controller 4 when power is supplied to the AC power port OUT while the vehicle battery B is charged. When an instruction to charge the vehicle battery B and an instruction to supply power to the AC power port OUT are input and the AC voltage detected by the charging voltage detector SV is a voltage corresponding to the voltage of the AC power port OUT, e.g., the rated voltage (200 V AC), the controller 4 controls the disconnect switches sw1, sw2, sw3, sw5, sw6, and sw7 so that the disconnect switches sw1, sw2, sw5, and sw6 enter a conducting state and the disconnect switches sw3 and sw7 enter a disconnecting state, and controls the changeover switch SW3 so that the other terminal of the charging port IN is connected to the other terminals of the AC power ports out1 and out2. The controller 4 controls the operation of the bidirectional charger 2 so that the bidirectional charger 2 converts the AC power output from the external power source P into the DC power to supply the DC power to the vehicle battery B. This allows the power supply to the AC power port OUT while charging the vehicle battery B using the AC power output from the external power source P.

### Second Example of Operation of Controller 4

The following will describe a second example of operation of the controller 4 when power is supplied to the AC power ports out1 and out2 while the vehicle battery B is charged. When an instruction to charge the vehicle battery B and an instruction to supply power to the AC power ports out1 and out2 are input and the AC voltage detected by the charging voltage detector SV is a voltage corresponding to the voltage of the AC power ports out1 and out2, e.g., the rated voltage (100 V AC), the controller 4 controls the disconnect switches sw1, sw2, sw3, sw5, sw6, and sw7 so that the disconnect switches sw3, sw5, sw6, and sw7 enter a conducting state and the disconnect switches sw1 and sw2 enter a disconnecting state, and controls the changeover switch SW3 so that the other terminal of the charging port IN is connected to the other terminals of the AC power ports out1 and out2. The controller 4 controls the operation of the bidirectional charger 2 so that the bidirectional charger 2 converts the AC power output from the external power source P into the DC power to supply the DC power to the vehicle battery B. This allows the power supply to the AC power ports out1 and out2 while charging the vehicle battery B using the AC power output from the external power source P.

### Third Modification

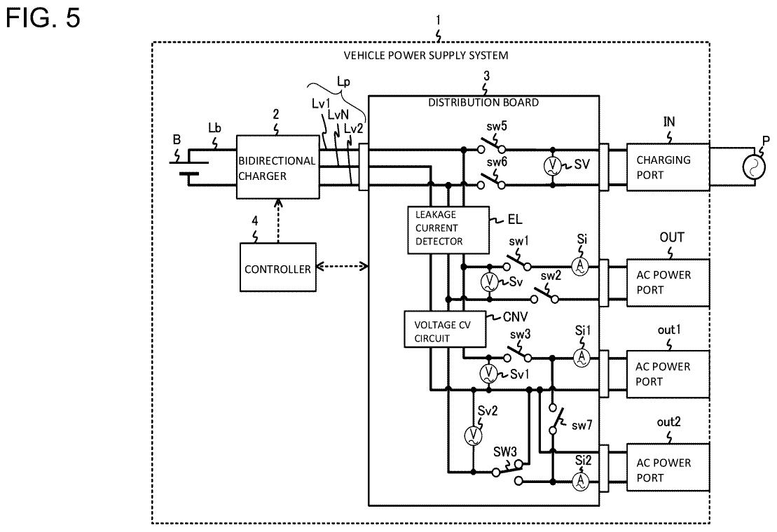

FIG. 5 is a diagram of the vehicle power supply system 1 according to a third modification. In FIG. 5, the same components as those illustrated in FIG. 4 are denoted by the same reference numerals, and the description thereof will be omitted.

The vehicle power supply system 1 illustrated in FIG. 5 differs from the vehicle power supply system 1 illustrated in FIG. 4 in that the distribution board 3 further includes a voltage conversion circuit CNV.

The voltage conversion circuit CNV steps down an external input AC voltage (e.g., 200 V AC) input from the external power source P into a converted AC voltage (e.g., 100 V AC).

The power distribution circuit of the distribution board 3 illustrated in FIG. 5 outputs the external input AC voltage to the AC power port OUT, and outputs the converted AC voltage output from the voltage conversion circuit CNV to the AC power ports out1 and out2.

### Third Example of Operation of Controller 4

The following will describe a third example of operation of the controller 4 when power is supplied to the AC power ports OUT and out1 while the vehicle battery B is charged. When an instruction to charge the vehicle battery B and an instruction to supply power to the AC power ports OUT and out1 are input and the voltage detected by the charging voltage detector SV is a voltage corresponding to the voltage of the AC power port OUT, e.g., the rated voltage (200 V AC), the controller 4 controls the disconnect switches sw1, sw2, sw3, sw5, sw6, and sw7 so that the disconnect switches sw1, sw2, sw3, sw5, and sw6 enter a conducting state and the disconnect switch sw7 enters a disconnecting state, and controls the changeover switch SW3 so that the other terminal of the charging port IN is connected to the other terminal of the AC power port out1. The controller 4 controls the operation of the bidirectional charger 2 so that the bidirectional charger 2 converts the AC power output from the external power source P into the DC power to supply the DC power to the vehicle battery B, and controls the voltage conversion circuit CNV so that the voltage conversion circuit CNV converts the AC voltage of 200 V AC output from the external power source P into an AC voltage of 100 V AC to output the AC voltage of 100 V AC to the AC power port out1. This allows the output of the AC voltage from the external power source P to the AC power port OUT and the output of the AC voltage from the voltage conversion circuit CNV to the AC power port out1 while charging the vehicle battery B using the AC power output from the external power source P.

### Fourth Example of Operation of Controller 4

The following will describe a fourth example of operation of the controller 4 when power is supplied to the AC power ports OUT, out1, and out2 while the vehicle battery B is charged. When an instruction to charge the vehicle battery B and an instruction to supply power to the AC power ports OUT, out1, and out2 are input and the voltage detected by the charging voltage detector SV is a voltage corresponding to the voltage of the AC power port OUT, e.g., the rated voltage (200 V AC), the controller 4 controls the disconnect switches sw1, sw2, sw3, sw5, sw6, and sw7 so that the disconnect switches sw1, sw2, sw3, sw5, sw6, and sw7 enter a conducting state, and controls the changeover switch SW3 so that the other terminal of the charging port IN is connected to the other terminals of the AC power ports out1 and out2. The controller 4 controls the operation of the bidirectional charger 2 so that the bidirectional charger 2 converts the AC power output from the external power source P into the DC power to supply the DC power to the vehicle battery B, and controls the voltage conversion circuit CNV so that the voltage conversion circuit CNV converts the AC voltage of 200 V AC output from the external power source P into an AC voltage of 100 V AC to output the AC voltage of 100 V AC to each of the AC power ports out1 and out2. This allows the output of the AC voltage from the external power source P to the AC power port OUT and the output of the AC voltage from the voltage conversion circuit CNV to each of the AC power ports out1 and out2 while charging the vehicle battery B using the AC power output from the external power source P.

Similarly to the configuration of the vehicle power supply system 1 illustrated in FIG. 1, the configuration of the vehicle power supply system 1 illustrated in FIG. 5 according to the third modification does not need to change the configuration of the bidirectional charger 2, thereby allowing standardization of the bidirectional charger 2 across vehicles with different types and specifications.

### Fourth Modification

The vehicle power supply system 1 according to a fourth modification is capable of supplying power to the AC power ports OUT, out1, and out2 using the DC power output from the vehicle battery B while charging the vehicle battery B using the AC power output from the external power source P. The configuration of the vehicle power supply system 1 according to the fourth modification is identical to the configuration of the vehicle power supply system 1 according to the second modification illustrated in FIG. 4. In the second modification, the bidirectional charger 2 only charges the vehicle battery B, and the AC power supplied to each AC power port is delivered from the AC power input from the external power source P to the charging port IN. However, in the fourth modification, the bidirectional charger 2 charges the vehicle battery B and supplies the AC power to each AC power port.

The bidirectional charger 2 according to the fourth modification converts the AC power input from the external power supply line Lp into the DC power to supply the DC power to the vehicle battery B, and also converts the DC power output from the vehicle battery B into the first AC power (e.g., 200 V AC) and the second AC power (e.g., 100 V AC) to supply the AC power to the external power supply line Lp. That is, the bidirectional charger 2 according to the fourth modification supplies a single-phase three-wire AC so as to supply the AC voltage of 200 V AC between the voltage line Lv1 and the voltage line Lv2, the AC voltage of 100 V AC between the voltage line Lv1 and the neutral line LvN, and the AC voltage of 100 V AC between the voltage line Lv2 and the neutral line LvN.

The power distribution circuit of the distribution board 3 according to the fourth modification supplies the first AC power input from the external power supply line Lp to the AC power port OUT, and supplies the second AC power input from the external power supply line Lp to each of the AC power ports out1 and out2.

### Fifth Example of Operation of Controller 4

The following will describe a fifth example of operation of the controller 4 when power is supplied to the AC power ports OUT, out1, and out2 while the vehicle battery B is charged. When an instruction to charge the vehicle battery B and an instruction to supply power to the AC power ports OUT, out 1, and out2 are input, the controller 4 controls the disconnect switches sw1, sw2, sw3, sw5, sw6, and sw7 so that the disconnect switches sw1, sw2, sw3, sw5, and sw6 enter a conducting state and the disconnect switch sw7 enters a disconnecting state, and controls the changeover switch SW3 so that the voltage line Lv2 of the external power supply line Lp is connected to the one terminal of the AC power port out2. The controller 4 controls the operation of the bidirectional charger 2 so that the bidirectional charger 2 converts the AC power output from the external power source P into the DC power to supply the DC power to the vehicle battery B and so that the bidirectional charger 2 converts the DC power output from the vehicle battery B into the first AC power and the second AC power to output the first AC power to the AC power port OUT and to output the second AC power to each of the AC power ports out1 and out2. This configuration allows the power supply to the AC power ports OUT, out1, and out2 using the DC power output from the vehicle battery B while charging the vehicle battery B using the AC power output from the external power source P. In order to supply power to a specific AC power port, it is sufficient to cause a disconnect switch corresponding to the specific AC power port to enter a disconnecting state (in order to supply power to the AC power port out2, the changeover switch SW3 is connected to the other terminal of the AC power port out2).

Similarly to the configuration of the vehicle power supply system 1 illustrated in FIG. 1, the configuration of the vehicle power supply system 1 according to the fourth modification does not need to change the configuration of the bidirectional charger 2, thereby allowing standardization of the bidirectional charger 2 across vehicles with different types and specifications.

What is claimed is:

1. A vehicle power supply system comprising:
a charging port connected to an external power supply line;
a bidirectional charger connected to the external power supply line and a vehicle battery line, the bidirectional charger being configured to convert an AC power input from an external power source via the charging port and the external power supply line into a DC power to supply the DC power to a vehicle battery via the vehicle battery line, or convert the DC power input from the vehicle battery via the vehicle battery line into the AC power to supply the AC power to the external power supply line;
an AC power port;
a distribution board including: a power distribution circuit configured to distribute the AC power input from the external power supply line to the AC power port; and a leakage current detector configured to detect leakage current; and
a controller configured to control an operation of the bidirectional charger.

2. The vehicle power supply system according to claim 1, wherein
the vehicle power supply system includes a plurality of the AC power ports,
the power distribution circuit distributes the AC power input from the external power supply line to the AC power ports, and
the distribution board includes a plurality of voltage detectors or a plurality of current detectors, the voltage detectors respectively corresponding to the AC power ports, the current detectors respectively corresponding to the AC power ports.

3. The vehicle power supply system according to claim 1, wherein
the vehicle power supply system includes a plurality of the AC power ports, and
the distribution board includes a plurality of disconnect switches, each of the disconnect switches being connected between one of the AC power ports and the external power supply line or between one of the AC power ports and the charging port.

4. The vehicle power supply system according to claim 1, wherein
the charging port is connected to the external power supply line via the distribution board.

5. The vehicle power supply system according to claim 1, wherein
the vehicle power supply system includes:
a plurality of the AC power ports; and
a charging voltage detector configured to detect a voltage input from the charging port, and
the controller controls so that the AC power input from the charging port is supplied to some of the AC power ports corresponding to the voltage detected by the charging voltage detector.

6. The vehicle power supply system according to claim 1, wherein
the vehicle power supply system includes a first AC power port and a second AC power port,
the distribution board includes a voltage conversion circuit that converts an external input AC voltage input from the charging port into a converted AC voltage, and
the power distribution circuit outputs the external input AC voltage to the first AC power port, and outputs the converted AC voltage output from the voltage conversion circuit to the second AC power port.

7. The vehicle power supply system according to claim 1, wherein
the vehicle power supply system includes a first AC power port and a second AC power port,
the bidirectional charger converts the AC power input from the external power supply line into the DC power to supply the DC power to the vehicle battery, and converts the DC power output from the vehicle battery into a first AC power and a second AC power to supply the first AC power and the second AC power to the external power supply line, and
the power distribution circuit supplies the first AC power input from the external power supply line to the first AC power port, and supplies the second AC power input from the external power supply line to the second AC power port.
